(19) United States
(12) Patent Application Publication
(10) Pub. No.: US 2013/0075420 A1
(43) Pub. Date: Mar. 28, 2013

(54) Fluid Dispenser with Cleaning/Maintenance Mode

(71) Applicants: Paul Francis Tramontina, Harleysville, PA (US); Malcolm C. Halls, Milton, GA (US); Ralph Hallett Dean, JR., Alpharetta, GA (US)

(72) Inventors: Paul Francis Tramontina, Harleysville, PA (US); Malcolm C. Halls, Milton, GA (US); Ralph Hallett Dean, JR., Alpharetta, GA (US)

(21) Appl. No.: 13/241,568

(22) Filed: Sep. 23, 2011

(51) Int. Cl. B67D 7/14

(52) U.S. Cl. 222/1; 222/52; 222/333

(57) ABSTRACT

The present invention provides an automatic liquid/foam dispenser with a deactivation means that allows cleaning/maintenance of the nozzle and sink without the dispenser dispensing the liquid/foam during cleaning/maintenance.

### FIELD OF THE INVENTION

The present invention generally relates to a fluid dispenser having a deactivation/reactivation means for a cleaning/maintenance mode.

### BACKGROUND OF THE INVENTION

Users of public restroom facilities often desire that all of the fixtures in the restroom operate automatically without being touched by the user's hands. This desire is generally due to the increased user awareness of the degree to which germs and bacteria may be transmitted from one person to another in a public restroom environment. As a result, many public restrooms are being transitioned to “hands-free” or “no-touch” restrooms, where all of the fixtures, including toilet and urinal units, hand washing faucets, soap dispensers, towel dispensers and door opening mechanisms, are automatic and operate without being touched by a user. It is believed by many users that hands-free or no-touch public restroom facilities reduce the opportunity for transmission of viruses and bacteria which may result from contact with fixtures in a public restroom.

In office buildings and other similar upscale buildings, the building owner or manager many times wants to offer upscale public restroom facilities to match the buildings décor. One way the building owner or manager can provide an upscale public restroom is to provide in-counter soap dispensers, rather than wall mounted units or on-counter dispensers. In-counter soap dispensers generally have a dispensing nozzle above the counter. Typically, in-counter soap dispensers have a reservoir, which holds the soap, and pump to move the soap from the reservoir to the nozzle. The reservoir and pump are generally mounted underneath the counter. In-counter soap dispensers are known in the art. See, for example, U.S. Pat. No. 6,142,342, U.S. Pat. No. 6,467,651 and U.S. Patent Application Publication US2009/0166381 A1.

However, these in-counter soap dispensers present a problem to the cleaning crews charged with cleaning the restrooms where the in-counter automatic dispensers are located. Since the automatic dispensers are designed to dispense the soap from the nozzle when a user's hand is detected underneath the nozzle, when the cleaning crew cleans the sink, the automatic soap dispenser dispenses soap, usually to the sink the cleaning crew is trying to clean. As a result, it is difficult for the cleaning crew to effectively clean the sink or the nozzle of the dispenser.

To overcome this problem, many cleaning crews will disconnect the power supply to the automatic dispenser to prevent unwanted shots of soap from being dispensed into the sink during cleaning. However, disconnecting the power supply presents other problems. The automatic soap dispenser could be damaged during disconnecting of the power supply, for example the battery compartment cover could be broken, the power cord could become frayed, the cleaning crew could forget to reconnect the power supply after cleaning or a combination thereof. In addition, in office buildings and other public restroom facilities, there are generally 2 or more sinks with the automatic soap dispensers. Disconnecting the power supply for each automatic soap dispenser and reconnecting the power supply adds time to the cleaning of the restrooms. Further, there is always the chance that cleaning crew will not reconnect the power supply, which could result in users of the restroom facilities without soap to wash their hands.

There is a need in the art for a quick and easy way for a cleaning crew to shutdown the automatic soap dispenser for a short period of time and where the soap dispenser automatically returns to the dispensing mode after the period of time. This will facilitate the cleaning of the restroom facility by saving the cleaning crew the time and burden of disconnecting and reconnecting the power supply to the automatic soap dispensers. The present invention solves this problem in the art.

### SUMMARY OF THE INVENTION

Generally stated, the present invention provides an easy to maintain automatic fluid dispenser having a deactivation/reactivation means which will deactivate the dispenser for a period of time and will automatically reactivate the dispenser.

In an embodiment of the present invention, provided is an electronic fluid dispenser. The electronic fluid dispenser has a reservoir for holding a fluid to be dispensed; a pump having an inlet and an outlet, wherein the pump draws the fluid from the reservoir through the inlet and expels the fluid through the outlet; a dispensing tube directly or indirectly connected to the outlet of the pump; a nozzle which is adapted to receive the dispensing tube and to dispense the fluid to a user; a motor and an attenuator in communication with the motor, wherein the attenuator activates the pump to dispense the fluid from the dispenser when the motor is activated. In addition, the fluid dispenser has a processor in communication with the motor; a sensor to detect the presence of a user, where the sensor in communication with the processor such that when the sensor detects the presence of a user, the sensor provides an input to the processor. The dispenser also has a switching means for deactivating the fluid dispenser. This switching means is in communication with the processor such that when the switching means is activated, the switching means provides an input to the processor, and the processor is configured to cease the dispenser from dispensing the fluid for a period of time when the processor receives the input from the switching means.

In another aspect of the present invention, provided is a method of deactivating a fluid dispenser for a period of time. The method has the steps of a) providing a fluid dispenser having a motor, a pump, a sensor, a processor and a switching means; b) activating the switching means; c) sending a signal from the switching means to the processor; and d) having the processor deactivate the fluid dispenser for a period of time when the signal is received from the switching means.

In further embodiments of the present invention, the switching means may be a mechanical switch or an electronic switch. Examples of mechanical switches include, for example, push button switches and toggle switches. Examples of electronic switches include, for example, a touch screen, a sensor, a pattern recognition program, a remote transmitter with a wireless receiver.

In a further embodiment of the present invention, the processor may be programmed to cease operation of the dispenser for a set period of time, such as 15 seconds to 10 minutes, typically between 20 seconds and 5 minutes, or more typically between 30 seconds and 3 minutes.

In an additional embodiment of the present invention, the processor can be programmed to cease operation of the dispenser until another event occurs prior to the end of the time period. An example of this embodiment, the processor my adjust the range of the sensor from a short range sensor to an extended range sensor. When the sensor no longer detects activity in the sink or the time period has lapsed, the dispenser reverts back to it dispensing operation.

The present invention provides an easy to maintain fluid dispenser which will allow a cleaning or maintenance personal to clean the sink and surrounding countertops without the dispenser dispensing the fluid during the cleaning process.

### BRIEF DESCRIPTION OF THE DRAWINGS

FIG. 1 shows a fluid dispenser with a reservoir attached to a dispensing portion of the dispenser.

FIG. 2 shows a fluid dispenser with a top portion and a bottom portion separated.

FIG. 3 shows a cut-away view of a pump mechanism useable in the fluid dispenser.

FIG. 4 shows a perspective view of the top portion of the dispenser with the cover removed.

FIG. 5A shows a front view of a motor power transmission system usable in the present invention.

FIG. 5B shows a side view of an actuator drive wheel and an actuator guide member of an embodiment of the present invention.

FIG. 5C shows a back side view of an actuator guide member of an embodiment of the present invention.

FIG. 5D shows a top view of a motor power transmission system embodiment usable in the present invention.

FIG. 6A shows an exemplary wiring diagram useable in a dispenser of the present invention with an external switch.

FIG. 6B shows an exemplary wiring diagram useable in a dispenser of the present invention with the sensor providing the switch means.

FIG. 7A shows a flow diagram useable in for the processor of the present invention allow the dispenser to go into a cleaning/maintenance mode.

FIG. 7B shows an alternative flow diagram useable in for the processor of the present invention allow the dispenser to go into a cleaning/maintenance mode.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

### DETAILED DESCRIPTION OF THE INVENTION

In the following detailed description of the present invention, reference is made to the accompanying drawings which form a part hereof, and which show by way of illustration, specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the present invention. The following detailed description is, therefore, not to be taken in a limiting sense, and the scope of the present invention is defined only by the appended claims, along with the full scope of equivalents to which such claims are entitled.

The dispenser of the present invention may be an in-counter dispenser or a above-counter dispenser. The above-counter dispenser may be a wall mounted dispenser such that the fluid is conveyed to the delivery spout via a delivery tube between the pump and the nozzle. Generally, however, the present invention will be more useful in in-counter dispensers. Therefore, the present invention will described in terms of the in-counter dispenser which is mounted through the counter in a restroom or other facility where hand cleaning or sanitizing may be needed.

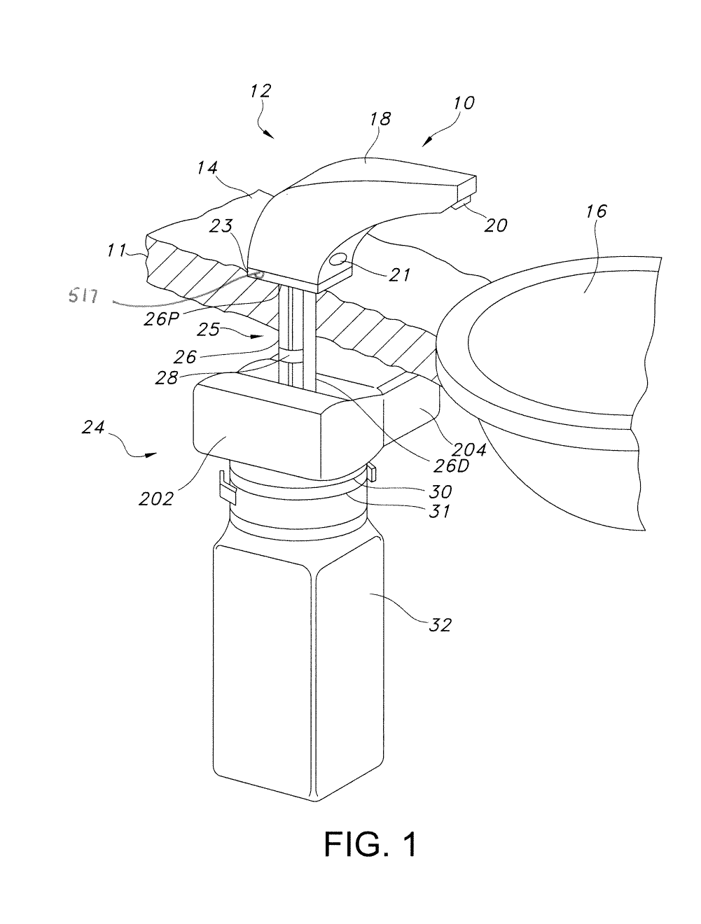

To gain a better understanding of the present invention, attention is directed to the Figures of the present specification. FIG. 1 illustrates an automatic dispenser apparatus 10 of the present invention, mounted in a counter 11 in a typical restroom facility. As shown, the dispenser apparatus includes a dispenser fixture 12 having an above-counter portion 14 located adjacent to a sink bowl 16. As shown, above-counter portion 14 includes a dispensing head or nozzle 18 having a delivery spout 20 extending from the dispensing head 18. Delivery spout 20 is positioned and configured in a conventional manner to supply fluid to the hand or hands of a user. As shown, the delivery spout 20 is positioned over the sink bowl 16, so that in an event that the fluid is unintentionally dispensed from the dispensing apparatus, the fluid will make its way into the sink bowl 16, rather than the counter 11. To dispense the fluid from the dispenser apparatus, a user passes their hand or hands under the delivery spout 20, where a sensor 21 detects the hand or hands or the user under the delivery spout 20. Suitable sensors useable in the present invention are any type of sensor that will detect the presence of a user's hand or hands under the delivery spout 20. An exemplary type of sensor is an infrared (IR) sensor. When the sensor 21 detects the user's hand or hands under the delivery spout, an electronic means is activated and a quantity of the fluid delivered to the user's hand.

The dispenser fixture 12 includes an under-counter portion 24 having a mounting system 25 securing the dispenser fixture 12 to the counter. The mounting system 25 has an elongated tube 26, which is a generally elongated hollow tube, extending through a hole defined in counter 11. By “hollow”, it is intended that a tube has a passage or channel (not shown in FIG. 1) that extends through the elongated tube 26 from proximate end 26P of the elongated tube 26, which is located above the counter 11, to the distal end 26D of the elongated tube 26 located below the counter 11. The elongated tube 26 has a flange 23 on the proximate end 26P of the elongated tube 26 that the flange 23 is positioned above the counter 11. The flange 23 is of a size which is larger than the hole in the counter 11 and the flange 23 serves to keep the elongated tube 26 from falling through the counter 11. As is shown in FIG. 1, the mounting system 25 also has an anchoring mechanism 28 associated with the portion of the elongated tube 26 which extends below the counter 11. The mounting system shown in FIG. 1 is one type of mounting system which may be used in the present invention and is described in more detail in U.S. Patent Application Publication US200910166381, which is hereby incorporated by reference in its entirety. It is noted that other types of mounting systems may also be used. For example, the mounting system 25 may be a threaded elongated tube and the anchoring mechanism may be a nut threaded onto the threads of the elongated tube (not shown).

The under-counter portion 24 also has a connecting member 30, located at the distal end 26D of the elongated tube 26. The connecting member 30 is removably connected to the distal end 26D of the elongated tube 26 at a top end of the connecting member 30. The connecting member 30 supports a reservoir assembly 32 which contains the fluid which is to be dispensed from the dispenser apparatus 10. The reservoir assembly 32 is removably connected to the connecting member 30 to the lower end 31 of the connecting member, also referred to as the reservoir assembly connecting surface, such that the reservoir assembly 32 can be removed and replaced when the fluid has been expended from the reservoir assembly 32.

The dispensing apparatus 10 further has a motor housing 202 which is positioned between the distal end 26D of the elongated tube 26 and the connecting member. The motor housing 202 may also contain the control electronics which controls the automatic nature of the dispensing apparatus 10. Attached to the motor housing is a power supply housing 204, which holds the power supply or transformer used to power the automatic dispensing apparatus 10 of with the scope of the present invention.

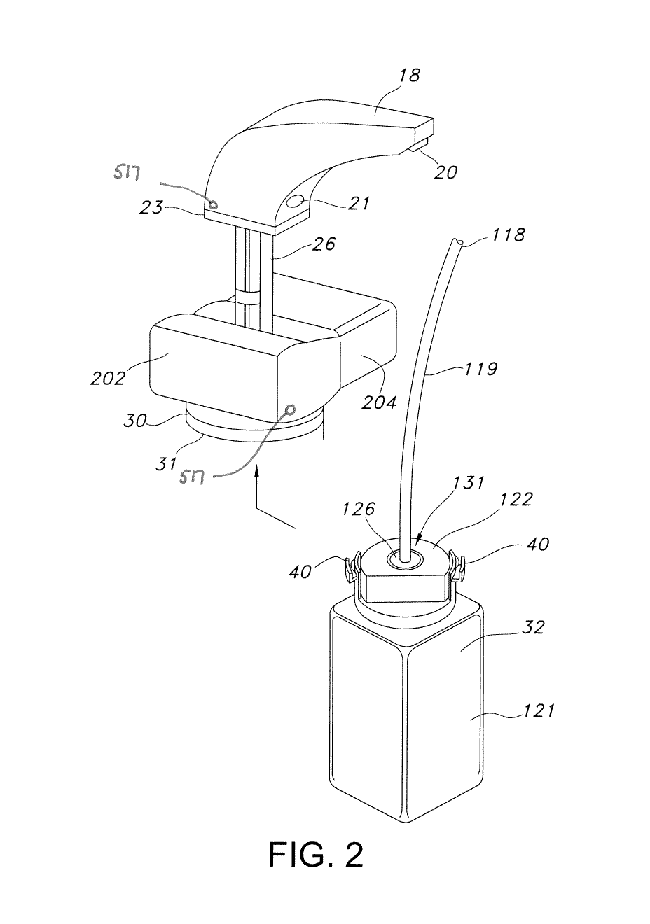

Referring to FIG. 2, in one embodiment the reservoir assembly 32 includes a main container 121 and a top portion 122. The top portion 122 has connecting means 40 which fit into complementary connecting means located on the connecting member 30. That is, the connecting member 30 serves to hold the reservoir assembly 32 on to the dispensing apparatus 10 by having a complementary connecting means that allow the connecting mean 40 to effectively hold the main container to the dispensing assembly. A suitable connecting means is disclosed in U.S. Patent Application Publication US200910166381, which is incorporated herein by reference.

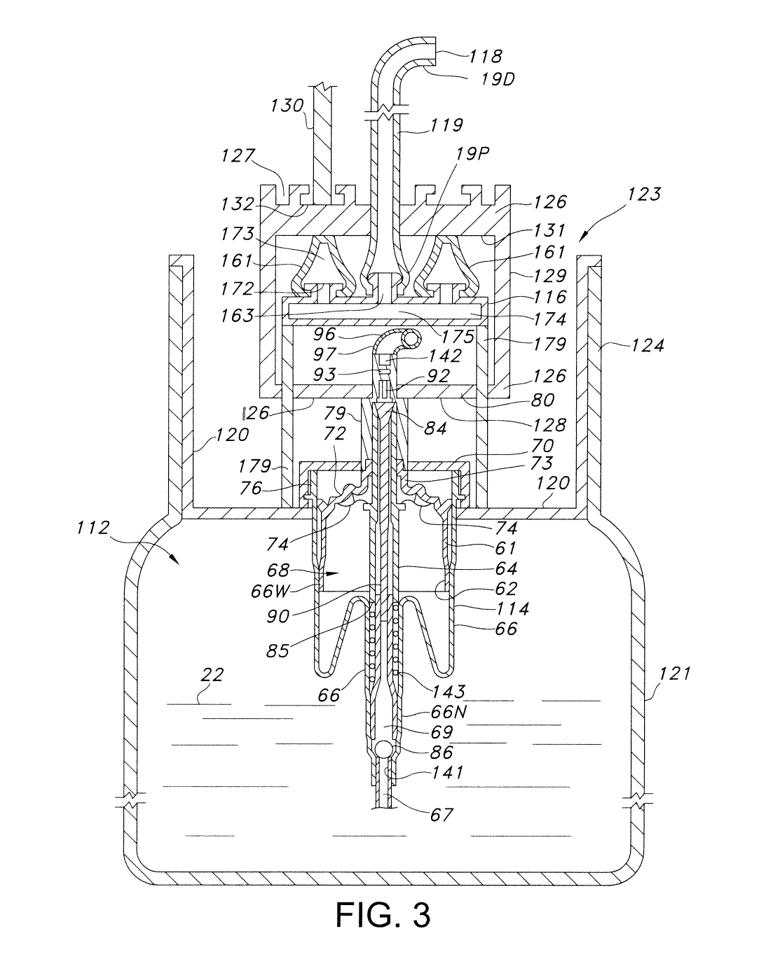

The reservoir assembly 32 has a dispensing tube 119 which extend out of the dispenser assembly. The dispensing tube 119 is generally an elongated tube which carries the fluid to be dispensed from the pump 114 (shown in FIG. 3) to the outlet 20 of the dispensing head or nozzle 18. The dispensing tube 119 has a proximate end 19P which is directly or indirectly connected to the outlet of the pump 142 and a distal end 19D. The fluid exits the dispensing tube 119 at the distal end 19D through the dispensing end 118. It is noted that the dispensing tube 119 may be separate from the reservoir assembly 32 and connected to the reservoir assembly when the dispense reservoir assembly 32 is top portion of the dispenser.

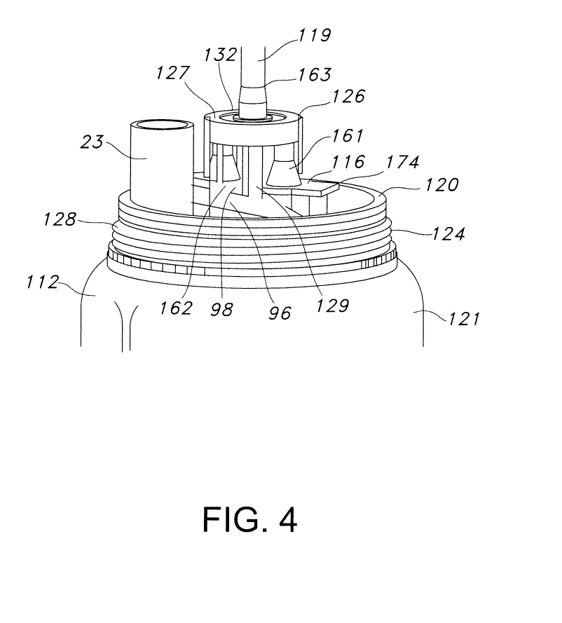

FIG. 2 shows the top portion 122 on the main container 121 and FIG. 3 shows the top portion removed from the main container 121, so that the internal works of the reservoir assembly 32 may be viewed. The main container 121 serves to hold and contain the fluid 22 which is to be dispensed from the dispenser 10. The main container 121 will have an opening 123 at the top, which is not shown in FIG. 2. The main container may also have a neck 124 near the opening, wherein the neck 124 of the main container forms the opening in the main container 121. Generally, the top portion 122 is attachable to the main container 121 at neck 124 of the main container 121. The top portion 122 may be secured to the main container 121 in a manner such that the top portion 122 is removably secured to the main container 121 or such that the top portion 122 is permanently secured to the main container 122. For example, the top portion 122 may be sealed to main container 121 using ultrasonic welding, adhesive or other suitable means of effecting a permanent attachment of the top portion 122 to the main container 121. If it is desirable that the top portion 122 is removable from the main container 121, the top portion 122 could be mated to the main container 121 using known methods, such as providing threads (not shown) on the top portion 122 and complementary threads 128 shown in FIG. 4 on the main container 121. Other similar methods could be used to removably secure the top portion 122 to the main container 121.

Located within the main container 121 is a pump 114, shown in FIG. 3. As shown in FIG. 3, the pump 114 is located in the opening 123 of the main container 121, generally in the neck 124 of the main container. It is also possible that the pump 114 may be located in the top 122 of the main container 121, or located at the bottom of the main container 121. For the purposes of describing the present invention, the pump will be described as being generally located in the neck 124 of the main container 121. Generally speaking, the pump 114 has an inlet 141, an outlet 142 and a recovery means 143. As with most pumps, the pump 114 has an idle stage, a discharging stage, and a charging stage. In the idle stage, which is shown in FIG. 3, the pump 114 mechanism is at rest and is not actively charging or discharging the fluid. The discharging stage of the pump is a stage in which a shot of the fluid is expelled from the pump 114 through the outlet 142 of the pump. In the charging stage of the pump 114, a shot of the precursor fluid 22 is drawn from the reservoir 112 through the inlet 141 into the pump 114. Typically, the fluid is drawn into the inlet of the pump 114 through a dip tube 67. The recovery means 143 allows the pump 114 to return to the idle stage from the end of the discharging stage. As the pump 114 is returning to the idle stage from the end of the discharging stage, the pump 114 is in the charging stage. Further details of a pump 114 useable in the present invention will be described below.

As shown in FIG. 3, the dispenser 10 may be provided with a pump mounting element 120. This pump mounting element 120 may be used to hold and/or secure the pump 114 and the suck back mechanism 116, when present, within the neck 124 of main container. The pump mounting element 120 fits into the opening 123 of the main container 121, which is shown in FIG. 3 and may be permanently mounted in the opening or removably mounted in the opening. Alternatively, the pump mounting element 120 may be associated with the top portion 122 of the dispenser. That is, the pump mounting element 120 may be removably connected to the top portion 122 of the reservoir assembly 32. In another alternative configuration, the pump mounting element 120 may be permanently connected with the top portion 122 of the dispenser such that the pump mounting element 120 forms a bottom surface of the top portion 122. Alternatively, the pump 114 could be housed within the main container 121.

As is shown in FIG. 3, the pump device 114 is located inside the neck 124 of main container 121, as described above, and serves to draw the fluid or fluid precursor 22 from the main container 121 of the reservoir 112 and force the fluid out the dispensing end 118 of the elongated tube 119 and out of the delivery spout 20 of the dispenser 10. The pump device 114 may be advantageously constructed from widely available “stock” components in order to enhance manufacturing efficiencies. In one embodiment of the present invention, pump device 114 is a foam pump of the type in widespread use with other foaming devices. Suitable pumps may be purchased from a variety of pump manufactures including, for example Rexam Airspray, Inc., having offices at 3768 Park Central Blvd, North, Pompano Beach, Fla., USA, and Rieke Corporation 500 W. ^{7th} Street, Auburn Ind., USA. A suitable commercially available pump is the F2 foaming pump available from Rexam Airspray, Inc. Many other models of foam pumps are also available on the market, and may be utilized depending on variables such as shot size and the like. It is also possible to use a commercially available pump device which may or may not be modified in several ways for use in dispenser apparatus 10, depending on the application or fluid to be dispensed from the dispenser apparatus 10.

To gain a better understanding of an exemplary pump that may be used in the present invention, attention is again directed to FIG. 3. As shown, pump device 114 is a foaming pump and includes an outer tubular piston 62 and an inner tubular piston 64 located inside of a pump cylinder 66. It is noted that non-foaming pumps may also be used in the dispenser of the present invention, when the fluid to be dispensed from the dispenser is a non-foaming fluid. As is shown, the pump cylinder 66 has a wide portion 66W and a narrow portion 66N. The outer tubular piston 62, the wide portion 66W of the pump cylinder 66 and the outer surface of the inner piston 64 form a first chamber 68, which is an air chamber. The inner piston 64 and the narrow portion 66N of the pump cylinder 66 form a second chamber 69, which is the fluid chamber. The pump device 114 further includes a cap element 70, which is maintained in an axially fixed relation with respect to pump cylinder 66. Cap element 70 is advantageously used to mount the pump device 114 within reservoir 112, and as shown, more particularly; to the pump mounting element 120, which is either contained within the main container 121 or the top portion 122 of reservoir assembly 32. In the illustrated embodiment, for example, pump mounting element 120 is configured as a disc-shaped member having a threaded portion 76. The outer threads of threaded portion 76 are engaged by the inner threads of cap element 70, as shown in FIG. 3. Other suitable means may be used to hold the pump assembly 114 in the reservoir 112.

An engaging element or attenuator 126 is in communication to the pump's piston assembly 61. Typically, the attenuator 126 will be physically connected to the piston assembly 61. In the illustrated embodiment, attenuator 126 is configured has a cylindrical portion 79, and a disc-shaped flange 80. It is generally the cylindrical portion 79 which is connected to the piston 61 of the pump 114. Typically, the attenuator 126 is generally located near the central axis of the reservoir assembly 32, which provides advantages discussed below. Other features of the attenuator 126 are an upper structure 127 and a lower structure 128 which are connected by a connecting structure 129. The upper structure has a top surface 132. Reciprocative movement of attenuator 126 will cause piston assembly 61 to move within the pump cylinder 66. Piston assembly 61 is normally urged into an upward position (rest position), shown in FIG. 3, due to the force of a pump recovery means 143. The pump recovery means may be a compressible member or, in an electronic configuration, the motor may be used to recover the pump. Suitable pump recovery means 143 includes a helical spring, as is shown in FIG. 3.

As is stated above, the pump assembly 114 shown in FIG. 3 is a foaming pump. The foaming pump shown mixes the liquid 22 from the main container 121 with air within the pump structure. The outer piston 62 contains air inlet openings 72, which allow air to pass through the outer piston 62 to enter the air chamber 68. In addition, the outer piston 62 is provided with an air exhaust passage 73, which allows the air present in the air chamber 68 to escape the air chamber 68. To prevent air in the air chamber 68 from exiting the air inlet opening 72, a check valve 74 is positioned near the air inlet opening 72 which opens during the charging stage and closes during the discharging stage of the pump 114. This check valve 74 also prevents air and/or fluid from entering the air chamber 68 during the charging stage from the air exhaust passage 73 during the charging stage of the pump. Operation of this check valve is described in more detail in U.S. Pat. No. 5,443,569 to Uehira et al., which is hereby incorporated by reference.

Pump device 114 is further provided with additional check valves 84, 85 and 86 to ensure proper flow of the liquid through the pump. Check valve 86, located at the base of pump cylinder 66, allows the liquid 22 to be drawn into a lower liquid chamber 69, through the inlet 141 of the pump when the inner piston 64 moves in an upward direction (charging stage). When inner piston 64 moves in a downward direction (discharging stage), check valve 85 allows the liquid 22 to be passed into an upper liquid chamber 90 from the lower liquid chamber 69. In addition, check valve 84 allow fluid to exit the upper pump chamber 90 into the mixing chamber 92. Both check valves 84 and 85 are opened at the same time and close at the same time. In the mixing chamber 92, air from the air chamber 68 is mixed with the liquid 22 from the upper liquid chamber 90. The mixing of the air and liquid creates a foam fluid which is forced through a porous member 93. The porous member 93 is in the form of a porous net or screen-like structure to create uniformity in the foam bubbles of the fluid. The fluid is then force through the outlet 142 of the pump 114. While a variety of different check valve configurations are contemplated, the illustrated embodiment utilizes common ball and seat valves. Other configuration of these elements may be used without departing from the scope of the present invention. Other structures and functional elements, such as seals and gaskets may be used in the pump device to the pump form leaking or improve the function of the pump. As is stated above, the pump 114 is described as a foaming pump; however, a foaming pump is one specific embodiment of the present invention. Non foaming pumps may also be used in the dispenser of the present invention as a second embodiment.

The fluid leaving the outlet 142 of the pump 114 is transported to the elongated tube 119 via a flexible tube 96. Generally, the outlet 142 of the pump 114 typically moves with the piston assembly 61. To counter act this movement, the outlet 142 of the pump 114 a flexible tube 96 has a first end 97 attached to the pump outlet 142. The second end 98 of the flexible tube 96 is attached to an inlet 162 of a stationary member 174, is shown in FIG. 4. Referring back to FIG. 3, the stationary member 174 has a passage 175. The stationary member 174 also has an outlet 163, which is connected the elongated tube 119. The stationary member is supported or held in place by a mount 179. By having the stationary member 174 and the flexible tube 96, the movement of the pump piston assembly is not transferred to the dispensing tube 119.

A suck back mechanism 116 may be optionally included within the dispenser. Suck back mechanisms are described in U.S. patent application Ser. No. 12/329,904, filed on Dec. 8, 2008, which is incorporated by reference, and provides a means to prevent the dispenser from dripping into the sink between uses. Generally, the suck back mechanism 116 is separate and distinct element from the pump 114. Also the suck back mechanism 116 has at least one resilient member 161 capable of storing fluid which may be connected to the stationary member 174. The resilient member 161 is generally hollow structures having an opening 172 located near the portion of resilient member 161 which is to be positioned at or near the stationary member 174. The hollow portion 173 of the hollow structure allows the resilient member 161 to store the fluid. Generally, the suck back mechanism 116 operates by forcing the hollow structure of the resilient member 161 is to collapse, thereby forcing the fluid within the hollow portion 173 out of the hollow portion. Then the resilient member 161 is allowed to its original shape and size, which creates a vacuum, which causes the fluid to be refilled in the resilient member. Generally, at the end of the discharging stage of the pump 114, undispensed fluid remains between the dispensing end 118 and the second opening 163 of the stationary member 174. A portion of the undispensed fluid is drawn into resilient member 161, which prevents the undispensed portion from dripping out of the dispensing end 118 of the dispensing tube 119 and helps prevent stringing of the fluid dispensed to the user with the undispensed fluid. The suck back mechanism 116 may operate independently from the pump 114 or may operate in conjunction with the pump 114. When operated separately from the pump, the suck back mechanism does not rely upon the recovery means 143 of the pump. When operated in conjunction with the pump, the pump's recovery means 143 assists recovery of the resilient members during the charging stage of the pump. The first opening 162 of the stationary member 174 is connected to the outlet 142 of the pump 114.

Optionally, one further element that may be present is a filling port 23, as is shown in FIG. 4, which allows the reservoir 112 to be filed with the fluid.

To activate the actuator 126 to dispense the fluid from the dispenser apparatus 10, an actuator rod 130 contacts the top surface 132 of the actuator 126, as is shown in FIG. 3. Alternatively, the actuator rod may be connected to the top surface 132 of the actuator 126. The actuator rod 130 may contact the top surface 132 of the actuator 126 by passing through an actuator opening 131, shown in FIG. 2, located in the top portion 122 of the reservoir assembly 32. The actuator opening 131 is generally positioned about the center line of the top portion 122, as is shown in FIG. 2, as is the upper surface 132 of the attenuator. In one embodiment of the present invention, the tube 119, connecting the dispensing end 118 to the second opening 163 will be centrally located in the actuator opening 131, as is shown in FIG. 2. The actuator opening 131 may be a single opening such that the actuator rod 130 can come into contact with top surface 132 of the actuator 126.

As the actuator rod 130 depresses the actuator 126, the actuator 126 depresses the piston assembly 61, including both the outer tubular piston 62 and the inner tubular piston 64 of the pump, transitioning the pump 114 from the rest stage to the discharging stage. Depressing the resilient members 161, when present, also causes any fluid within the hollow portion 173 to be expelled from the resilient members 161 into the passage 175 and towards the dispensing end 118 of the dispenser. In addition, fluid is expelled from the pump 114 through the outlet 142 of the pump 114 into the flexible tube 96, which carries the passage 175. The fluid enters the passage 175 and joins the fluid expelled from the resilient member 161, when present. The fluid is also expelled from the delivery spout 20 of the dispenser 10. At the end of the actuator's 126 depressing the resilient member 161, when present, and the piston assembly 61 of the pump 114, the pump recovery means 143 causes the pump to transition from the discharging stage to the charging stage. During the charging stage of the pump 114, the actuator 126 is returned to its rest position, shown in FIG. 3, which in turn allows the resilient member 161, when present, to return to its original shape from a compressed state. As the resilient member 161 is returned to its original shape, a vacuum is created; causing a portion of any undispensed fluid between the suck back mechanism 116 and the delivery spout 20 to be drawn back into the resilient member 161. It is this vacuum created and the drawing of the portion of the undispensed fluid into the resilient member 161, prevents the problems of stringing and dripping from the delivery spout 20 of the dispenser. As is stated above, the suck back mechanism is optionally present. If the suck back mechanism is not present, then the fluid is dispensed from the outlet 142 to the flexible tube, to the stationary member 174 and to the delivery tube 119.

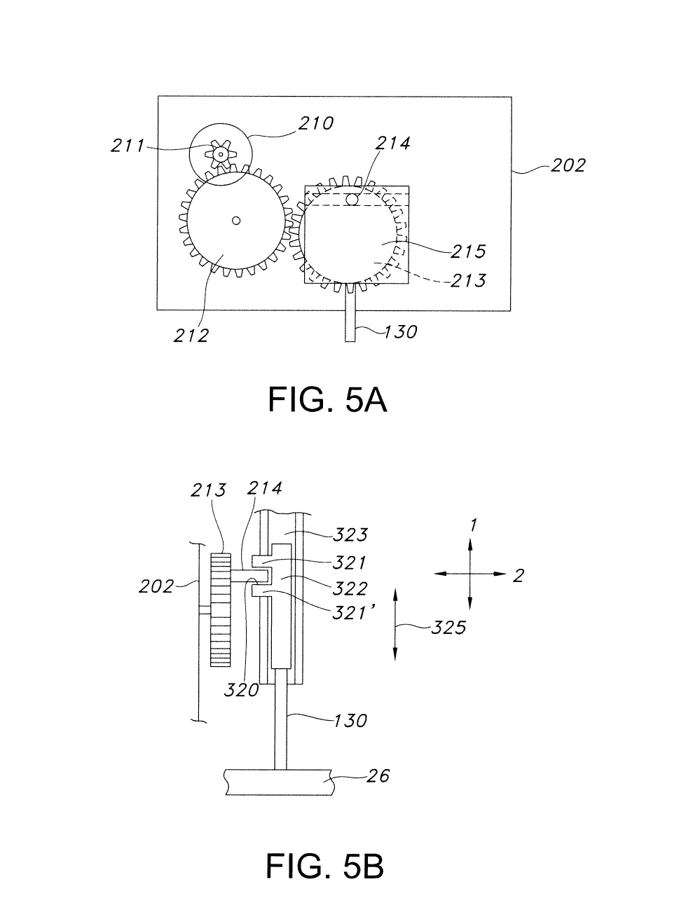

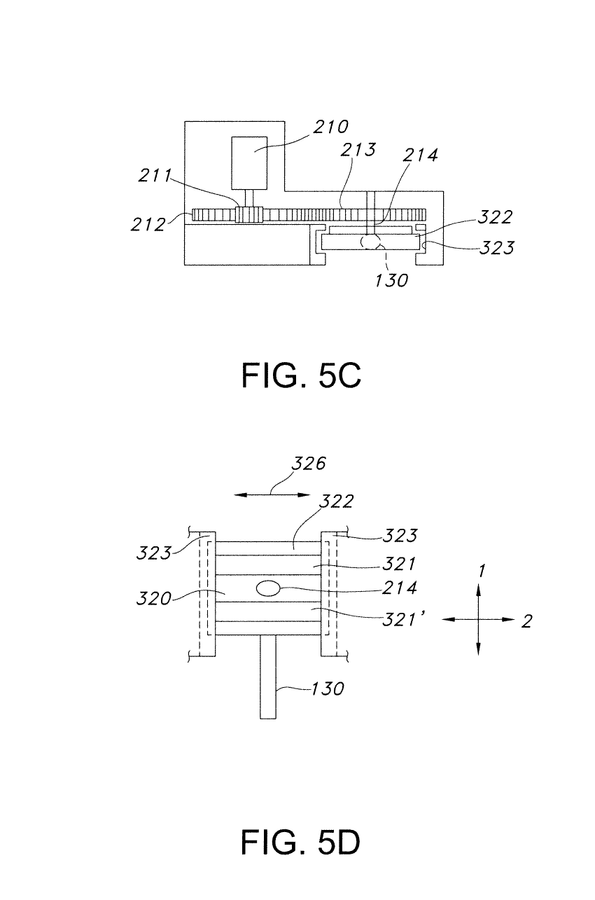

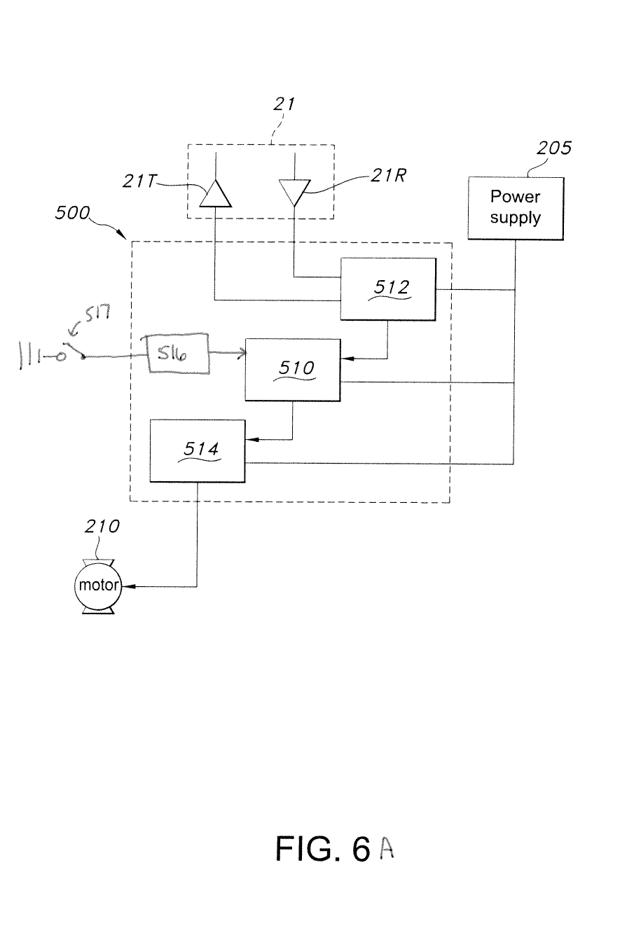

In the present invention, the dispenser assembly 10 is a hands-free dispenser. As such, dispenser assembly 10 is electronically actuated by an electronic means such as a motor. In one embodiment, the sensor 21 is selected such that the sensor 21 is able to detect a user's hands under the spout 20. The sensor 21 may be an IR sensor or other similar type of sensors could sense a user's hands under the spout 20. When the sensor 21 detects a user's hands under the spout 20, the sensor 21 sends a signal to the control circuitry that a user has requested a dose of the fluid by placing their hands under the spout. The control circuitry in turn sends a signal to a motor 210, shown in FIG. 5, to activate the motor for a set cycle.

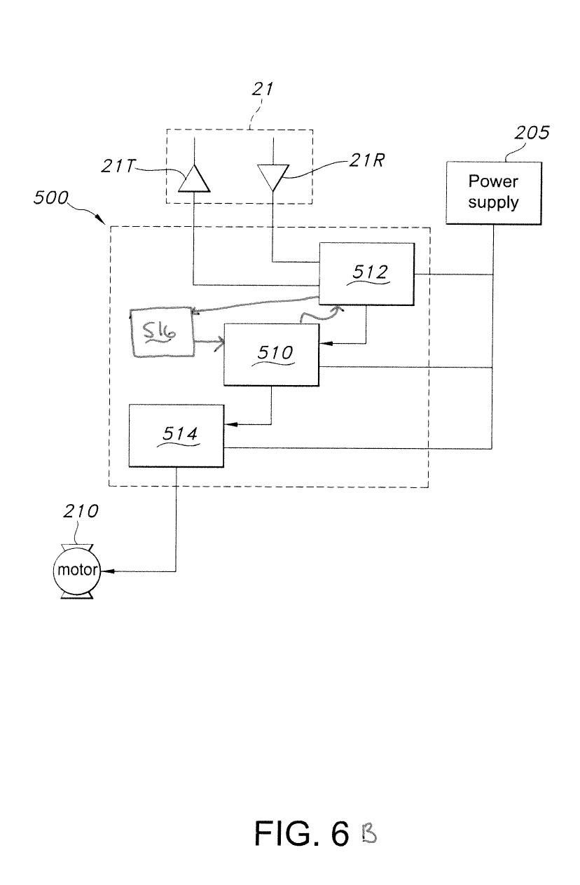

In a particular embodiment, the sensor 21 is electrically connected to a control panel (not shown) having control circuitry 500, shown in FIGS. 6A and 6B and is discussed in more detail below. The control panel, with its control circuitry, may be located in the motor housing 202 or the power supply housing 204. Optionally, the control panel may be located is a separate compartment or housing. The actual location of the control panel and control circuitry is not critical to the present invention.

Typically, the power supply housing 204 may be separated from the motor housing so that the power supply may be replaced when needed. That is, the power supply is disconnectable and reconnectable to the motor housing 202. To ensure that power is transferable from the power supply 205 in the power supply housing 204 to the motor housing 202, electrical contact points may be used on both the motor housing 202 and power supply housing 204. These electrical contact points are in complementary positions, meaning that when the power supply 205 in the power supply housing 204 is attached to the motor housing 202, an electrical connection is made. The power supply 205 powers the entire unit, including the sensor 21, control circuitry 500, including the processor and the motor 210.

The power supply 205 for the fluid dispensing system of the present invention may include disposable DC batteries (not shown). Alternatively, the power supply 205 may be a closed system which requires that the entire power supply be replaced as a single unit. Although not shown in the figures, an AC to DC adapter/transformer may be utilized to provide an alternate source of power to the fluid dispenser. This embodiment may be particularly useful wherein the fluid dispenser is mounted in close proximity to an AC outlet or when it is desirable to power multiple dispensers from a centrally located transformer of suitable configuration and power. The number of batteries used to power the motor will depend on the motor selected for the dispenser. Disposable batteries useable in the present invention include 9 volt batteries, 1.5 volt batteries, such as D-cell or C-cell batteries, or other similar batteries. The exact type of battery selected for use is not critical to the present invention so long as the power supplied to the motor is compatible for the motor. For applications where the fluid dispenser will be used under low usage situations, rechargeable batteries could be used. If the dispenser is to be used in a bright light situation, the batteries could be solar rechargeable batteries.

Once the processor 510 receives the input from the sensor, the processor sends power to the motor 210, which in turn actuates the pump. To gain a better understanding of a possible configuration of the motor housing 202, attention is now directed to FIGS. 5A, 5B, 5C and 5D. The motor housing 202 houses a motor 210, gears 211, 212, which are engaged with motor 210 and an additional gear 213 which drives an actuator rod 130. The motor driven actuator rod 130 is housed in the motor housing 202 and extends from the motor housing 202 through an opening present in the lower surface of the connecting member 30. Any method may be used to drive the motor driven actuator rod 130. In a typical operation of the electronic fluid dispensing system, the motor driven actuator rod 130 contacts the actuator 126 and pushes the actuator 126 downward to activate the pump 114, one or more times, to expel a dose of the fluid from the delivery spout 20 of the dispensing head 18.

Numerous ways may be used to transfer power from an activated motor 210 to the motor driven actuator rod 130. For example, the motor 210 may drive a series of wheels, gears or other energy transmission means to the actuator rod 130 which extends and contacts the actuator 126. In one embodiment of the present invention, which is intended to be an exemplary means that may be used to drive the actuator rod 130, the drive wheel 213 has a post or shaft 214 extending from one area of the gear body near the periphery 215, as is shown if FIGS. 5A and 5B. As the motor 210 turns the motor drive wheel 211, the motor drive wheel 211 in turn rotates one of more wheels 212. In FIG. 5A, a single wheel 212 is shown; however, it may be desirable to have more wheels to reduce the rotational speed of the actuator drive wheel 213, so the pump 114 is activated in a controlled manner. It is within the skill of those skilled in the art to select the ratio of drive wheel so that the appropriate speed is achieved of the actuator drive wheel 213. It is noted the term “wheel”, as used herein, is intended to cover any wheel like mechanism, including wheels per se and other wheel-like mechanisms, such as gears. Generally, gears are desirable, since gears are less likely to slip during use.

As is shown in FIG. 5B, the actuator drive wheel 213 has a shaft 214 extending from a non-central area of the actuator drive wheel 213, which makes the shaft rise and lower in the direction 325 as the actuator drive wheel 213 turns. This shaft 214 is fitted into a horizontal channel 322 present in the actuator guide member 320. The horizontal channel 322 is generally in the horizontal axis 2. The horizontal channel 322 is created by two horizontal protrusions 321 and 321′ extending from one of the sides of the actuator guide member 320. As the actuator drive wheel turns, the shaft 214 travels in a circular path and has a vertical movement 325 in the vertical axis 1, shown in FIG. 5B and a horizontal movement 226 in the horizontal axis 2, shown in FIG. 5C. The vertical movement 325 of the shaft 214 causes the actuator guide member 220 to move up and down in the vertical axis 1, which in turn moves causes the motor driven actuator rod 130 to also move in an up and down manner in the vertical axis. Below the channel 322 present on the actuator guide member 220 is the actuator rod 130. The actuator guide member 320 is held in place so that the movement of the actuator guide member is in an up and down manner in the vertical axis and not side to side or front to back. The actuator guide member 320 may be held in place, for example by providing vertical guide slots 323 so that the lateral sides of the actuator guide member 320 are held in place on the horizontal axis. These vertical guide slots 323 maybe provided in the motor housing 202 as is shown in FIGS. 5B, 5C and 5D.

As is mentioned above, the shaft 214 also has a horizontal movement 326 in the horizontal axis 2. This horizontal movement is essentially unwanted. To account for the horizontal movement, the shaft is allowed to move horizontally in the horizontal axis 2 along the channel 322 in the actuator guide member. Therefore, the channel 322 controls the essentially unwanted horizontal movement 326 of the shaft 214.

The hands-free fluid dispensing systems may also have additional features. For example, dispensing head 18 may have indicator lights to signal various events, such as, recognition of a user, low battery, empty soap reservoir, or other conditions such as a motor failure. Examples of such lights include low power consumption lights, such as LED (light emitting diodes).

In the present invention, the control circuitry 500 contains a processor 510 which has an on-board clock. The processor 510 is in communication with both the sensor 21, through the sensor circuit 512 and the motor 210, through the motor circuit. A general diagram of a control circuit 500 which may be used in the present invention is shown in FIGS. 6 A and 6B. Generally described, the control circuit has a processor 510, a sensor circuit 512 and a motor drive circuit 514. Each of the sensor circuit 512, the processor 510 and motor drive circuit 514 are powered by the power supply 205. In operation of this control circuit 500, the sensor circuit 512 sends a signal to the transmitter 21T of the sensor 21 to transmit a signal from the transmitter 21T. The receiver 21R of sensor 21 receives a signal back from the transmitter 21T. When a user's hand is detected by the receiver 21R, the sensor circuit 512 sends a signal to the processor 510 which is recognized by the processor as a signal to activate the motor 210, since a user's hands were detected. The processor 510, in turn, sends a signal to the motor drive circuit 514. The motor drive circuit 514 activates the motor 210, which in turn activates the attenuator rod 130, the attenuator 126 and pump 114, causing the dispenser of the present invention to dispense the fluid. This description is only for the basic components present in the control circuitry. Addition other components, such as warning lights for condition like low battery, empty soap reservoir, or other conditions such as a motor failure could be included in the control circuitry by those skilled in the art. Exemplary control circuitry for sensors, lights and buttons is known to those skilled in the art and is shown, for example in U.S. Pat. No. 6,929,150 to Muderlak et al., which is hereby incorporated by reference.

In the present invention, there is a switching means which serves to deactivate the fluid dispenser. The switching means is in direct or indirect communication with the processor 510. When the switching means is activated, the switching means sends a signal to the processor 510 and the processor 510 is configured to deactivate or cease operations of the dispenser by stopping the dispenser from dispensing a fluid for a period of time. This deactivation of the dispenser will be referred to herein after as a “cleaning mode” or a “maintenance mode”. The switching means is typically a switch 517, shown in FIG. 6A, and may be a mechanical switch, or an electronic switch. By “electronic switch”, it is intended to be a switch which operates other than by mechanical means. Examples of mechanical switch include for example push button switches, or toggle switches. Generally, when toggle switches are used, a spring loaded or a momentary on/off switch will be generally selected. These types of switches allow a signal to be sent to the processer to place the dispenser into the cleaning or maintenance mode. Examples of electronic switches include touch screens or another type of switch which is electronically controlled, such as an electric eye or sensors. Another type of electron switch is a remote transmitter which is wirelessly connected to the control circuit 500 through a wireless receiver. Examples of wireless connections include WIFI, Bluetooth, cellular phone/internet and other similar wireless connections which are located in or near the dispenser assembly. Alternatively, the wireless connection could be made to a distant receiver, such as a computer, which is remote to the dispenser assembly. In that situation, the distant receiver may be hard wired, for example through phone lines or computer cables, to the distant receiver. The remote transmitter can be a key fob, a personal communication device such as a PDA or a cell phone and other similar devices. Another type of switching means is a software switch or soft switch. In a soft switch, an input is given to the processor 510, for example through a wireless connection which activates software such that the processor uses software to run the cleaning mode or maintenance mode.

In addition, the control circuit 500 may optionally have a switching circuit 516 which may be part of the switching means. The switching circuit 516 is in direct connection with the processor 510. As shown in FIG. 6A, the switching circuit 516, when present, will be generally connected to mechanical switch 517, such as a push button, a toggle switch, or an electronic switch, such as a switch located on a touch screen, for example an LCD or LED touch screen. Alternatively, the switching circuit 516 may be connected to the sensor circuit 512, as shown in FIG. 6B. When connected to the sensor circuit 512, the switching circuit 516 can take inputs from the sensor circuit as an electronic switch or soft switch input point. For example, the IR receiver 21R may be blocked for a period of time or blocked and unblocked in a particular pattern of a short period of time. Alternatively, a signal may be received from an IR transmitter. When the input of the blocking the IR receiver 21R for a period of time, or a pattern of blocking and unblocking is detected IR receiver 21R, and this input is sent to the sensor circuit 512, the sensor circuit 512 sends a signal to the switching circuit 516 and the switching circuit 516 sends a signal to the processor 510 to activate the cleaning mode. The processor 510 can be programed with a pattern recognition program. Alternatively, an portable IR transmitter, such as a key fob, may be provided to the maintenance team or cleaning crew. The maintenance team or cleaning crew uses the portable IR transmitter to send a signal through the IR receiver 21R. When the IR receiver 21R receives this signal from the portable IR transmitter, this signal is sent to the sensor circuit 512, which in turn sends a signal to the switching circuit 516 that the cleaning or maintenance mode is desired. The switching circuit 516 then conveys this signal to the processor 510, and the processor 510 will place the dispenser 10 in cleaning mode or maintenance mode for a period of time.

The processor 510 has an on-board clock function which can be used to determine the period of time in which the dispenser 10 will remain in the cleaning/maintenance mode. Generally, the processor 10 will be programed or configured to keep the dispenser 10 in the cleaning/maintenance mode for a set period of time. For example, the processor 510 determines the lapsed time between the switch activation requests for the cleaning/maintenance mode to the end of the designated time. During this time period, the dispenser is disabled and will not be able to dispense soap. Typically, the time period will be set for a period of time it will typically takes to clean a sink and the surrounding countertop. Typically the time period will be set to a period of time between about 15 seconds to about 10 minutes, more typically between about 20 second and 5 minutes and most typically between about 30 seconds and 3 minutes. Larger countertops and sinks will typically lead to longer to clean so the actual time may be set on the size of the area to be cleaned and the general speed of the cleaning crew.

Essentially any processor having a clock function may be used. Suitable processors include processors such as the 89LPC922 from available from Phillips. Other similar processors may be used in the present invention without departing from the scope of the present invention.

Generally, the dispenser 10 will have a means to adjust the set period of time, such as switches or variable resistors to adjust the set period of time. In an alternative embodiment of the present invention, the time period may be set by the amount of time in which the IR receiver 21R his blocked or based on the pattern inputted into IR receiver 21R. For example, if the IR receiver 21R is blocked for 3 seconds, the cleaning mode will last for 3 minutes; if the IR receiver 21R is blocked for 5 seconds, the cleaning mode will last for 5 minutes and so on. In this embodiment of the present invention, the generally the maximum amount of time will be about 10 minutes. It is further noted that the amount of time the IR receiver 21R is blocked in seconds does not necessary translate to the time the dispenser is in the cleaning mode in minutes on a 1 second:1 minute ratio. However, it is an easy translation for the cleaning crew to use to activate the cleaning mode. As such, for example, 4 seconds of blocking time could be a cleaning mode time of 2 minutes, 3, minutes, or 10 minutes, depending on the set-up of the dispenser. When a pattern is used to activate the cleaning/maintenance mode, the pattern should be such that it is a pattern that would not occur during normal use of the dispenser.

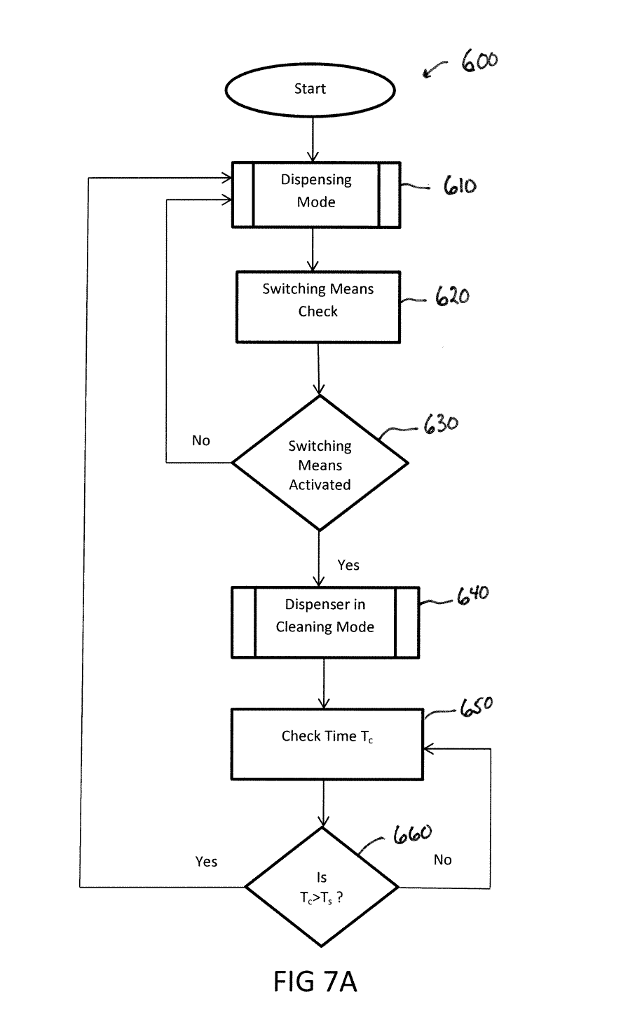

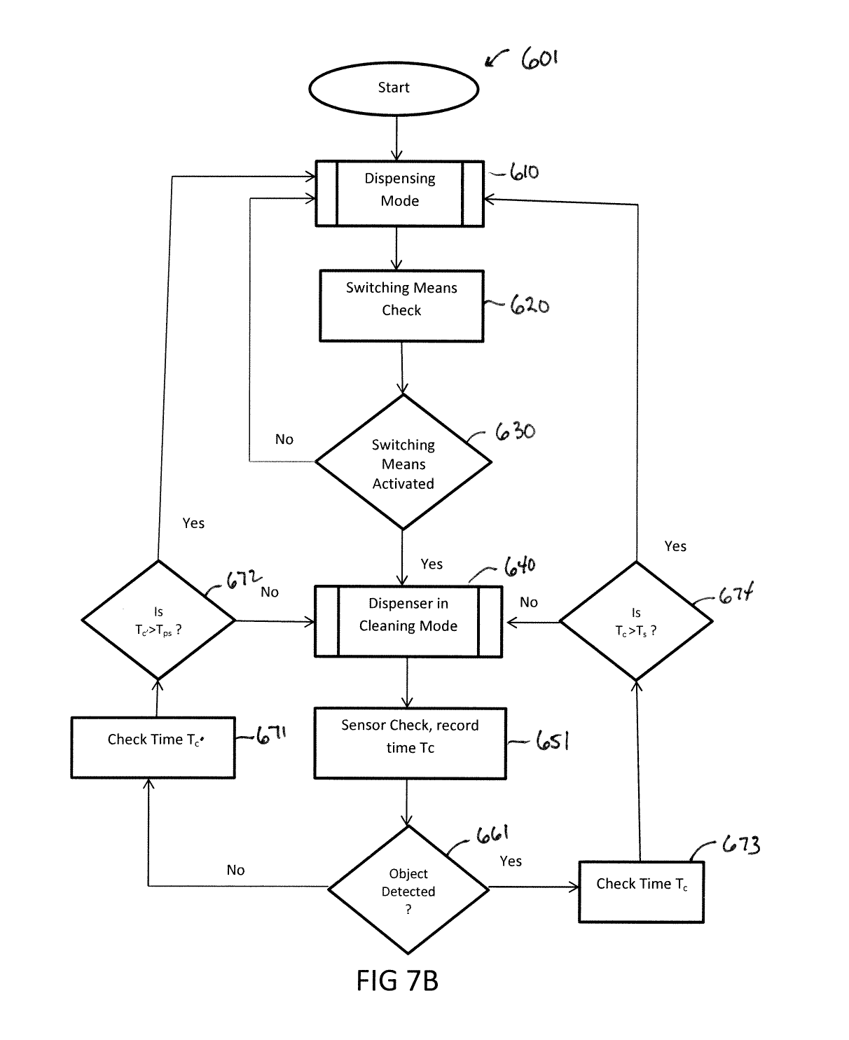

In an alternative embodiment, rather than shutting the dispenser down for a set period of time when the cleaning/maintenance mode is activated, the range of the sensor 21 could be changed from a close proximity to and extended range proximity sensor. This can be done by increasing the power to the IR transmitter 21T. Generally, the increase range of the sensor 21 will be increased to include the entire sink, rather than just under the nozzle 18. While set in the extended range proximity sensor, the sensor and the sensor circuit will continue to look for the cleaning crews hand or cleaning implements in the sink or countertop region in front of the nozzle. Once the cleaning crews hands or cleaning implements are not detected in the sink for a period or the surrounding areas for a set period of time, the dispenser automatically reverts back to the dispensing mode, converting the sensor 21 back to a close proximity sensor, such that the dispenser will dispense the fluid when the user's hand. Generally, if the sensor, while on the extended range, does not detect a cleaning crew's hand or cleaning implement, for a period of about 1 minute, the dispenser 10 will revert back to the dispensing mode. The actual time period could be longer or shorter, for example 30 seconds or 2 minutes. Again, the clock on the processor 510 can be used to measure this time period. Further, if this embodiment is used, it may be advantageous to place an upper time limit of about 10 minutes on the cleaning/maintenance mode, in case the sensor range is longer than the area of the sink. This aspect of the present invention is discussed in more detail below and is shown in FIG. 7B.

In a further aspect of the present invention, the processor may be configured to limit the number of times the dispenser 10 can be placed in the cleaning/maintenance mode in a 24 hour period. This will prevent users from disabling the system through intention or unintentional actions. For example, the processor could be configured to limit the number of cleaning/maintenance modes to 4, 5, 6 or more times in a 24 hour period. The actually number of times could be determined by each individual restroom based on typically number of cleaning that restroom receives in a given day.

The switch 517 of the switching means could be located on the nozzle 18, shown in FIG. 2, the flange 23, shown in FIG. 1 or on the motor housing 202, as is shown in FIG. 2. If the switch 517 is located on the flange 23 or the nozzle 18, it should be located such that the switch 517 is not easily seen or manipulated by a user. For example, the switch could be located on the side of the nozzle 18 opposite the sensor 21 or on the side of the flange 23 not visible to the user. Alternatively, the switch may be located on the motor housing 202, which is below the counter 11. In another embodiment, the switch could be locate separate from the dispenser but electrically connected to the dispenser. In a further embodiment, the switch could be in plain view of the user, or out of view of the user such that a tool is needed to activate the switch, such as a probe. An example of this would be a recessed switch that could be activated with a pencil, pen or other narrow protruding object.

In the present invention, the fluid dispensed from the dispenser may be a variety of fluids. Generally, the fluid dispensed will be a hand cleaning fluid, such as liquid soap, a liquid sanitizer, a gel soap, a foam soap precursor, a foaming sanitizer precursor or other similar hand cleaning or sanitizing liquid formulations. It is noted in the case of foaming soap precursor, or a foaming sanitizer precursor, these formulations are liquids before a foaming pump will convert these fluid to a foam.

Other features can include product recognition, where the reservoir assembly 32 has a product identification feature which can communicate with the control circuitry to identify the product being dispensed, or other features such as the size of the fluid pump in the reservoir assembly, the type of pump (fluid or liquid). The control circuitry would have a means to receive the product identification information. Exemplary product identification means includes RFID, optical sensor such as a bar code reader and other similar means.

Another feature which may be present in the fluid dispenser of the present invention is additional switches which may set the fluid dispenser to only dispense a single shot, or a double shot of the fluid being dispense. This type of functionality is described in U.S. Patent Application Publication 2011/00127291, entitled “Fluid Dispenser, published Jun. 2, 2011, which is hereby incorporated by reference in its entirety. Other switches or adjustments that could be used in a variable resistance switch which could be used to adjust and change the time period in which the dispenser 10 remains in the cleaning/maintenance mode.

The fluid dispensers of the present invention will generally delivery as much fluid soap necessary for a hand cleaning event. Generally, the amount of fluid will be up to about 3 ml or more of the fluid, depending on the nature of the hand cleaning or sanitizing fluid. For industrial applications, the upper limit for the amount of fluid being dispensed could be higher than 3 ml. For most hand washing events, the amount of the fluid will be less than 2 ml, and generally less than 1 ml. In a particular embodiment, the amount of the precursor delivered by the fluid dispenser is between about 0.45 ml and about 0.8 ml and more particularly, between 0.45 ml and 0.55 ml.

The present invention also relates to a method of deactivation a fluid dispenser for a period of time. The process includes
a. providing a fluid dispenser having a motor, a pump, a sensor, a processor and a switching means;
b. activating the switching means;
c. sending a signal from the switching means to the processor,
d. having the processor deactivate the fluid dispenser for a period of time, when the signal is received from the switching means.

When deactivated, the fluid dispenser is in a cleaning/maintenance mode which will prevent the dispenser from dispensing a fluid from the dispenser. The deactivation can be set to a preset length of time or can be such that other events occur prior to the end of the preset length of time to revert the dispenser back to the dispensing mode. When the cleaning/maintenance mode is a preset length of time generally the period of time will be between 15 seconds and 10 minutes; more typically between about 20 seconds and 5 minutes and most typically between about 30 seconds and 3 minutes. As described above, the dispenser is deactivated by deactivating the motor, and/or the sensor. In one aspect of the present invention, the processor deactivates the fluid dispenser by deactivating the sensor circuit for the set period of time when a signal is received from the switching mean.

To gain a better understanding of this aspect of the present invention attention is directed to FIG. 7A which shows the function of the processor 510 in the process 600 of the present invention in a flow chart form. At the beginning of the process 600, dispenser is in a dispensing mode 610. In this dispensing mode, the dispenser will dispense the fluid in accordance with the above description. The processor checks the switching means 620 on a regular basis to determine if the switching means has been activated 630. If the switching means has not been activated, the dispenser resumes in the dispensing mode 610. If the switching means has been activated, the processor places the dispenser in a cleaning/maintenance mode 640 and the processor notes the time at which the dispenser was placed in the cleaning/maintenance mode. The processor then checks the lapse time Tc 650 from the time the dispenser was placed in the dispensing mode as compared to a preset time Ts 660. If the lapse time Tc is greater than the preset time Ts, then the dispenser resumes the dispensing mode 610. If the lapse time Tc is less than preset time Ts, then the processor repeat steps 650 and 660 until the Tc is greater than Ts, at which point the dispenser resumes the dispensing mode 610. In this embodiment of the present invention Ts is the preset length of time described above in which the processor will keep the dispenser in the cleaning/maintenance mode.

In an alternative embodiment of the present invention, the processor activates the sensor in such a way that the sensor increases the range, as described above. To gain a better understanding of this aspect of the present invention attention is directed to FIG. 7B which shows the function of the processor 510 in the process 601 of the present invention in a flow chart form. At the beginning of the process 601, dispenser is in a dispensing mode 610. In this dispensing mode, the dispenser will dispense the fluid in accordance with the above description. The processor checks the switching means 620 on a regular basis to determine if the switching means has been activated 630. If the switching means has not been activated, the dispenser resumes in the dispensing mode 610. If the switching means has been activated, the processor places the dispenser in a cleaning/maintenance mode 640 and the processor increases the range on the sensor to detect objects in the sink or surrounding countertop to determine if the sink is still being actively cleaned. At this point, the processor continues to check the sensor 651 and determine if an object is detected in the sink 661. If an object in not detected in the sink or surround countertop, the processor checks the time Tc′ 671, which is the elapsed time from when no object is detected in the sink or the surrounding countertop. At this point, the elapsed time Tc′ is compared to a preset time Tps 672. If Tc′ is greater than Tps, the dispenser resumes in the dispensing mode 610. If Tc′ is less than Tps, the dispenser remains in the cleaning mode 640. Generally, the preset time Tps will be a short period of time, typically less than 2 minutes. In most cases, the preset time period will be set in a range of about 20 seconds to about 2 minutes, more typically in the range of about 30 seconds to 1 minute.

If an object is detected in sink or surrounding counter area, then the dispenser may remain in the cleaning mode 640 until an object is not detected in the sink or the surrounding counter area. In another aspect of the present invention, Ian object is detected, then the dispenser may optionally do a further time check. The processor then checks the lapse time Tc 673 from the time the dispenser was placed in the dispensing mode as compared to a preset time Ts 674. If the lapse time Tc is greater than the preset time Ts, then the dispenser resumes the dispensing mode 610. If the lapse time Tc is less than preset time Ts, then the processor retains the dispenser in the cleaning/maintenance mode 640 and the processer processor repeat steps 651 and 661 until the Tc is greater than Ts, if an object is still detected. When Tc is greater than Ts and the object is still detected, to account for the lapse time, the dispenser resumes the dispensing mode 610 to ensure that there is not an undesired malfunction with the transmitter 21T being in the extended range. In this embodiment of the present invention Ts is the preset length of time described above in which the processor will keep the dispenser in the cleaning/maintenance mode.

As is described above, the switching means may be activated by many different methods. In one aspect of the present invention the switching means may be activated by inputting a pattern into the sensor 21, and the processor 510 is configured to recognize the pattern which will cause the processor to deactivate the fluid dispenser by placing the dispenser into the cleaning mode. Another method, the switching means maybe activated by blocking the sensor for a duration of time, and the processor is configured to recognize the duration of time as a signal to deactivate the dispenser. In this aspect of the invention, the processor is configured to deactivate the dispenser in the cleaning mode for a period of time proportion to the period of time in which the sensor is blocked.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

We claim:

1. An electronic fluid dispenser comprising:
a. a reservoir for holding a fluid to be dispensed;
b. a pump having an inlet and an outlet, wherein the pump draws the fluid from the reservoir through the inlet and expels the fluid through the outlet;
c. a dispensing tube directly or indirectly connected to the outlet of the pump;
d. a nozzle which is adapted to receive the dispensing tube and to dispense the fluid to a user;
e. a motor;
f. an attenuator in communication with the motor, wherein the attenuator activates the pump to dispense the fluid from the dispenser when the motor is activated;
g. a processor in communication with the motor;
h. a sensor to detect the presence of a user, the sensor in communication with the processor such that when the sensor detects the presence of a user, the sensor provides an input to the processor; and
i. a switching means for deactivating the fluid dispenser, the switching means is in communication with the processor;
wherein when the switching means is activated, the switching means provides an input to the processor, and the processor is configured to cease the dispenser from dispensing the fluid for a period of time.

2. The dispenser according to claim 1, wherein the switching means comprises a mechanical switch.

3. The fluid dispenser according to claim 2, wherein the mechanical switch comprises a push button, or a toggle switch.

4. The fluid dispenser according to claim 2, wherein fluid dispenser further comprises a motor housing, wherein the processor and motor are located in the motor housing and the mechanical switch is located on the motor housing.

5. The fluid dispenser according to claim 2, wherein the mechanical switch is located on the nozzle.

6. The fluid dispenser according to claim 1, wherein the switching means comprises an electronic switch.

7. The fluid dispenser according to claim 6, wherein the electronic switch comprises a touchscreen, a sensor, a pattern recognition program, a remote transmitter with a wireless receiver.

8. The fluid dispenser according to claim 7, wherein the electronic switch is a pattern recognition program which is incorporated into the processor, wherein the processor is configured to recognize a pattern input from the sensor.

9. The fluid dispenser according to claim 1, wherein the sensor is located on a sensor circuit and the processor is configured to deactivate the sensor circuit for the set period of time when a signal is received from the switch means.

10. The fluid dispenser according to claim 1, wherein the period of time is between 15 seconds and 10 minutes.

11. The fluid dispenser according to claim 10, where the period of time is between 20 seconds and 5 minutes.

12. The fluid dispenser according to claim 11, wherein the period of time is between 30 seconds and 3 minutes.

13. The dispenser according to claim 1, further comprising a suck back mechanism located between the outlet of the pump and the dispensing tube.

14. The dispenser according to claim 1, wherein the fluid comprises a liquid soap, a liquid sanitizer, a gel soap, a foam soap precursor or a foaming sanitizer precursor.

15. The dispenser according to claim 1, wherein the nozzle is mounted above the counter via a mounting means which extends through the counter.

16. The dispenser according to claim 1, further comprising a power supply connected to the processor, sensor and motor.

17. The dispenser according to claim 1, wherein the dispenser is an in-counter dispenser with the nozzle and sensor located above the counter.

18. The dispenser according to claim 1, wherein the processor is programed to adjust the range of the sensor from a short range sensor to an extended range sensor, when the switching means is activated.

19. A method of deactivating a fluid dispenser for a period of time, said method comprising
a. providing a fluid dispenser having a motor, a pump, a sensor, a processor and a switching means;
b. activating the switching means;
c. sending a signal from the switching means to the processor,
d. having the processor deactivate the fluid dispenser for a period of time, when the signal is received from the switching means.

20. The method according to claim 19, wherein the set period of time is between 15 seconds and 10 minutes.

21. The method according to claim 20, where the set period of time is between 20 seconds and 5 minutes.

22. The method according to claim 21, wherein the set period of time is between 30 seconds and 3 minutes.

23. The method according to claim 19, wherein the sensor is located on a sensor circuit and the processor deactivates the fluid dispenser by deactivating the sensor circuit for the set period of time when a signal is received from the switch means.

24. The method according to claim 19, wherein the switching means is activated by inputting a pattern into the sensor, and the processor is configured to recognize the pattern which will cause the processor to deactivate the fluid dispenser.

25. The method according to claim 19, wherein the switching means is activated by blocking the sensor for a duration of time, and the processor is configured to recognize the duration of time as a signal to deactivate the dispenser.

26. The method according to claim 25, wherein the processor is configured to deactivate the dispenser for a period of time proportion to the period of time in which the sensor is blocked.

27. The method according to claim 19, wherein when the switching means is activated, the processor adjusts the range of the sensor from a short range sensor to an extended range sensor, wherein the processor continues to deactivate the dispenser so long as the sensor detects an object or and moving in or around a sink in which the dispenser is installed.

28. The method according to claim 27, wherein the processor has a maximum period of time before the sensor is reset to a short range sensor.
